(19) United States
(12) Patent Application Publication
(10) Pub. No.: US 2009/0322539 A1
(43) Pub. Date: Dec. 31, 2009

(54) MONITORING APPARATUS WITH A SENSOR UNIT

(76) Inventors: Po-Wen Jeng, Taichung City (TW); Liang Yuan-Sheng, (US); Chang Yao-Jen, (US); Chen Hsin-Tsang, (US); Chen Po-Nien, (US)

Correspondence Address: CHIEN-HUI SU, P.O. BOX 70-121 TAICHUNG, TAICHUNG CITY, 40899, TW

(21) Appl. No.: 12/165,630

(22) Filed: Jun. 30, 2008

(51) Int. Cl. G08B 23/00

(52) U.S. Cl. 340/573.1

(57) ABSTRACT

A monitoring apparatus includes a process unit, a sensor unit, a transmission unit and an illuminator unit. The sensor unit for detecting moving approaching objects is electrically connected to the process unit to send signals to the process unit. The transmission unit is electrically connected to the process unit for receiving signals from the process unit and adapted to be connected to a backend central control system for transmitting signals from the process unit to the backend central control system. The backend central control system sends a mode signal to the process unit via the transmission unit. The illuminator unit is electrically connected to the process unit and is controlled by orders from the process unit when the process unit determines status based on signals from the sensor unit and the mode signal.

### BACKGROUND OF THE INVENTION

1. Field of the Invention

The present invention relates to a monitoring apparatus, and more particularly to a monitoring apparatus with a sensor unit for detecting any moving object.

2. Description of Related Art

A conventional monitoring apparatus in accordance with the prior art comprises a people infrared sensor and a light sensor. The infrared sensor will detect moving people and the light sensor will detect the brightness of the environment. When the infrared sensor detects moving people and the light sensor detects the low brightness of the environment, an illuminator will be switched on automatically. The conventional monitoring apparatus lacks the function of central control. The operation of the conventional monitoring apparatus can not be controlled by a backend central control system. Each of the conventional monitoring apparatus works alone, and therefore it is impossible to set a plurality of monitoring apparatuses in the same time. Furthermore, the conventional monitoring apparatus lacks the functional of different mode. User needs the different function to achieve different purpose. For example, the illuminator will be kept closed when the sensor is detecting people or the illuminator will be kept closed in the day time but switch on in the night time when the sensor is detecting people. Besides, the conventional monitoring apparatus does not transmit any signal from the sensor to the backend central control system for monitoring and controlling the status.

The present invention has arisen to mitigate and/or obviate the disadvantages of the conventional monitoring apparatus.

### SUMMARY OF THE INVENTION

The main objective of the present invention is to provide an improved monitoring apparatus, in that a multi-mode and central controlled monitoring apparatus is acquired.

To achieve the objective, the monitoring apparatus includes a process unit, a sensor unit, a transmission unit, a memory unit and an illuminator unit. The sensor unit for detecting moving approaching objects is electrically connected to the process unit to send signals to the process unit. The transmission unit is electrically connected to the process unit for receiving signals from the process unit and adapted to be connected to a backend central control system for transmitting signals from the process unit to the backend central control system. The backend central control system sends a mode signal to the process unit via the transmission unit. The memory unit is electrically connected to the process unit for storing data from the process unit and being accessed data by the process unit. The illuminator unit is electrically connected to the process unit and is controlled by oders from the process unit when the process unit determines status based on signals from the sensor unit and the mode signal.

Further benefits and advantages of the present invention will become apparent after a careful reading of the detailed description with appropriate reference to the accompanying drawings.

### BRIEF DESCRIPTION OF THE DRAWINGS

FIG. 1 is a block diagram of a monitoring apparatus with a sensor unit in accordance with the present invention;

FIG. 2 is a schematic view showing the illuminator unit is switched on when the sensor unit detects moving approaching objects in the detecting mode;

FIG. 3 is a schematic view showing the illuminator unit is kept closed when the sensor unit does not detect any moving approaching object in the detecting mode; and

FIG. 4 is a schematic view showing the illuminator unit is kept closed when the sensor unit detects moving approaching objects in the normally closed mode.

### DETAILED DESCRIPTION OF THE INVENTION

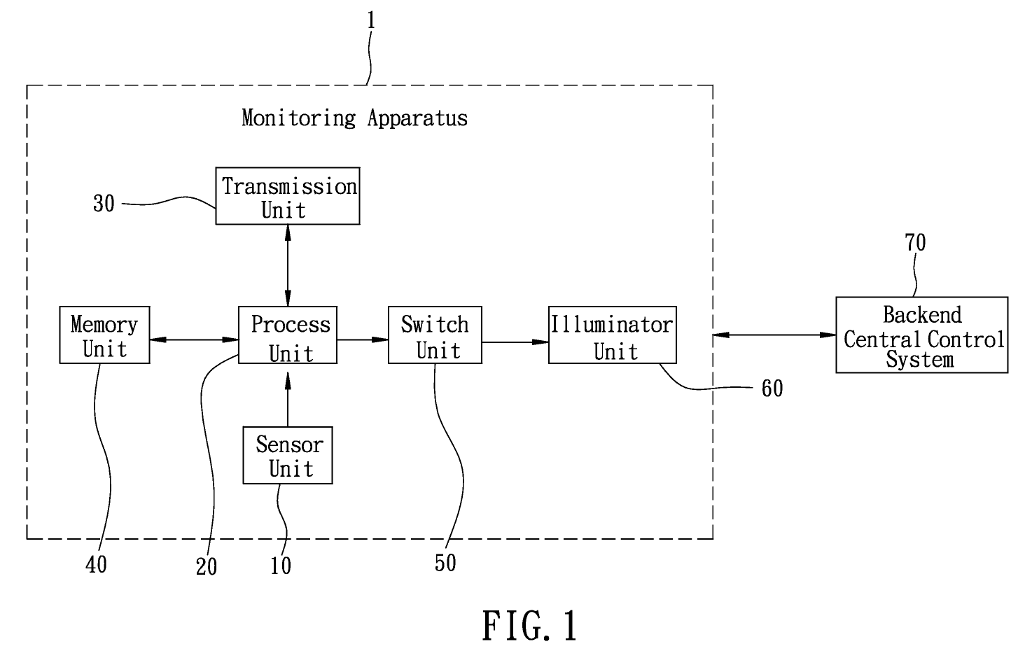

Referring to the drawings and initially to FIG. 1, a monitoring apparatus 1 in accordance with the present invention comprises a sensor unit 10, a process unit 20, a transmission unit 30, a memory unit 40, a switch unit 50, and an illuminator unit 60 respectively disposed therein.

The sensor unit 10 is a passive infrared sensor electrically connected to the process unit 20 for detecting moving approaching objects. When detecting moving approaching objects, the sensor unit 10 will send signals to the process unit 20.

The process unit 20 processes the signals from the sensor unit 10 and the processed signals is stored in the memory unit 40. The process unit 20 sends signals to transmission unit 30 and an order to the switch unit 50 after processing the signals from the sensor unit 10. Besides, the process unit 20 has a function of counting to count number of signal sending from the sensor unit 10 for monitoring the flow of people. The process unit 20 also has a function of timing to calculate a time interval when the sensor unit 10 detects objects or when the sensor unit 10 detects that an object stays behind.

The transmission unit 30 is electrically connected to the process unit 20 for receiving signals from the process unit 20. The transmission unit 30 is a wireless transmission unit adapted to be wirelessly connected to a backend central control system 70 for transmitting the signals from the process unit 20 to the backend central control system 70. The backend central control system 70 sends a mode signal to the process unit 20 via the transmission unit 30.

The memory unit 40 is electrically connected to the process unit 20 for storing data received from the process unit 20 and being accessed data by the process unit 20.

The switch unit 50 is a relay electrically connected to the process unit 20 and the illuminator unit 60. When receiving the order from the process unit 20, the switch unit 50 will control the illuminator unit 60 to switch on for a predefined time period.

The illuminator unit 60 is an LED light or a conventional bulb that is electrically connected to the process unit 20 via the switch unit 50. The illuminator unit 60 is controlled by the order from the process unit 20 via the switch unit 50 when the process unit 20 determines status based on the signals from the sensor unit 10 and the mode signal from the backend central control system 70.

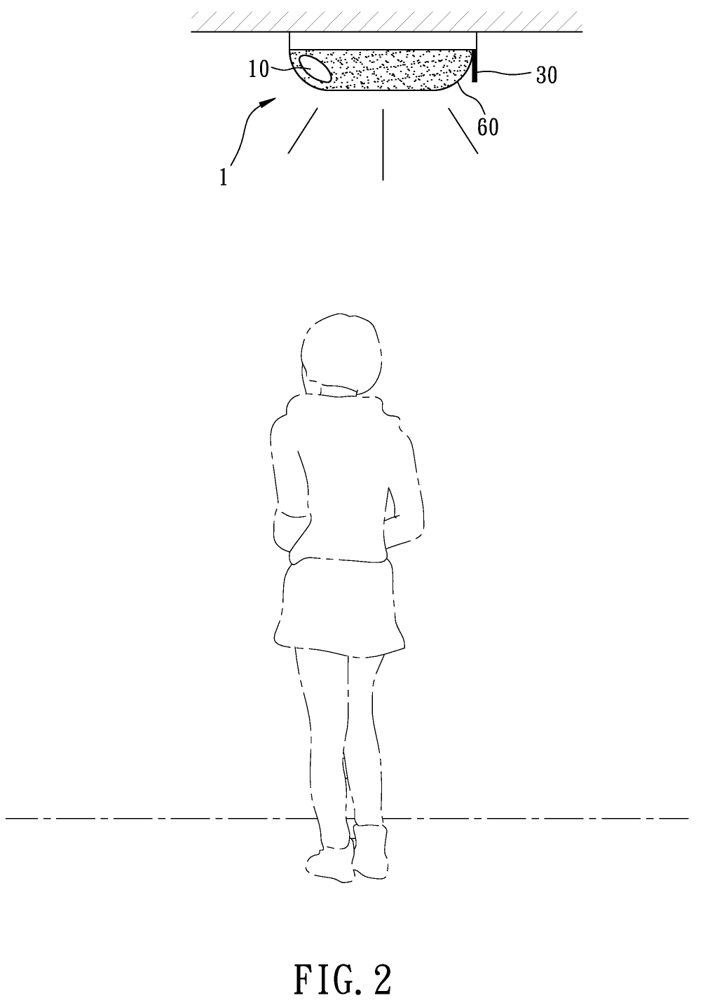

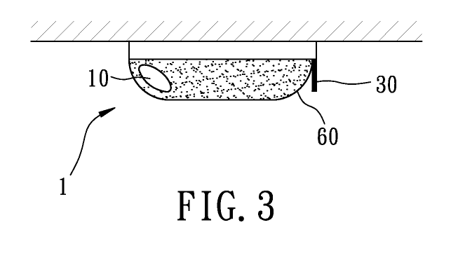

The mode signal from the backend central control system 70 controls the operation of the monitoring apparatus 1 as shown in FIGS. 2-4. When the mode signal is directed to a detecting mode, the process unit 20 determines the operation of the illuminator unit 60 base on the signals from the sensor unit 10. Referring to FIG. 2, the process unit 20 sends an order to the switch unit 50 to switch on the illuminator unit 60 when the sensor unit 10 detects moving approaching object in the detecting mode. On the contrary, the illuminator unit 60 is kept closed when the sensor unit 10 does not detect any object as shown in FIG. 3.

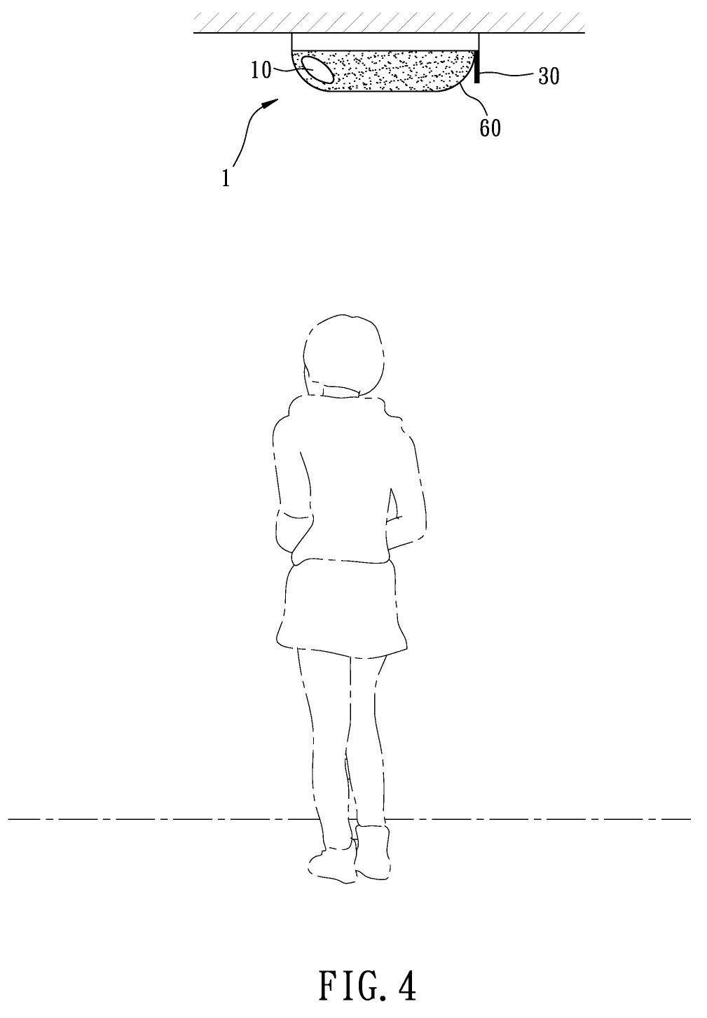

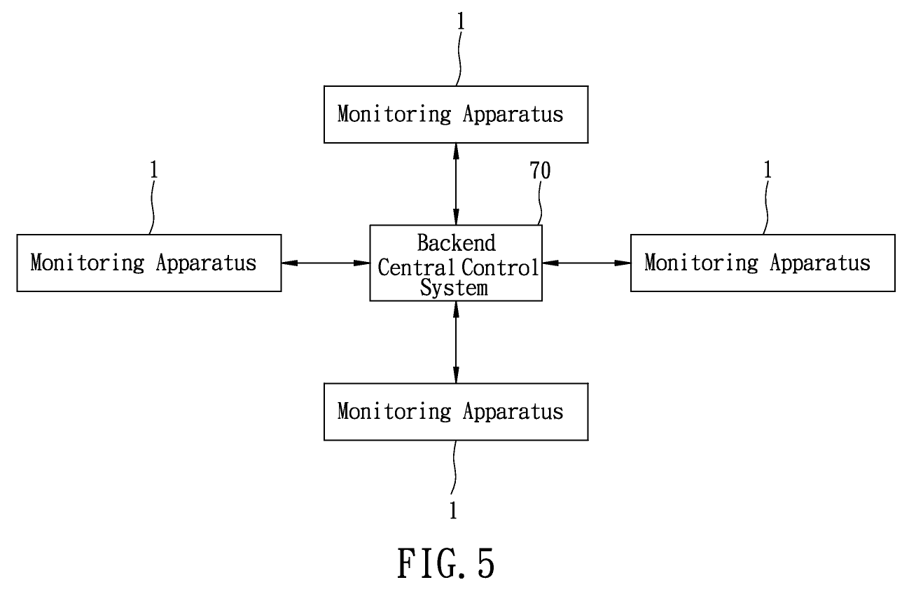

When the mode signal is directed to a normally closed mode, the illuminator unit 60 will be kept closed. Referring to FIG. 4, the process unit 20 does not send any order to the switch unit 50 to switch on the illuminator unit 60 when the sensor unit 10 detects moving approaching object in the normally closed mode.

When the mode signal is directed to a time mode, multiple time periods are defined in the time mode. The process unit 20 sends an order to the illuminator unit 60 to switch on when the sensor unit 10 detects moving approaching object during at least one of the multiple time periods. The process unit 20 does not send any order to the illuminator unit 60 to switch on when the sensor unit 10 detects moving approaching object during the others of the multiple time periods.

When the mode signal is directed to an abnormal report mode, the process unit 20 will determines which an abnormal status is. For example, the sensor unit 10 detects a great number of objects in a predetermined time interval, the sensor unit 10 detects that a person stays behind for a predetermined time interval, or the sensor unit 10 detects that a person gets into a room and does not come out for a long time. The process unit 20 sends signals to the backend central control system 70 via the transmission unit 30 for warning when the process unit 20 determines the abnormal status in the abnormal report mode.

Referring to FIG. 5, the backend central control system 70 sends the mode signal to multiple monitoring apparatuses 1 and receives signals from the different multiple monitoring apparatuses 1. The multiple monitoring apparatuses 1 are controlled in the same time. Furthermore, entire environment is monitored by the backend central system via integration of signals from the different multiple monitoring apparatuses 1. The backend central control system 70 also sends different multiple mode signals to the different multiple monitoring apparatuses 1 to enhance the practicability and flexibility.

Although the invention has been explained in relation to its preferred embodiment, it is to be understood that many other possible modifications and variations can be made without departing from the spirit and scope of the invention as hereinafter claimed.

What is claimed is:

1. A monitoring apparatus comprising:
a process unit for receiving, processing, and sending signals;
a sensor unit for detecting moving approaching objects electrically connected to the process unit to send signals to the process unit;
a transmission unit electrically connected to the process unit for receiving signals from the process unit, the transmission unit adapted to be connected to a backend central control system for transmitting signals from the process unit to the backend central control system and receiving a mode signal from the backend central control system, wherein the transmission unit sends the mode signal to the process unit when receiving the mode signal from the backend central control system;
a memory unit electrically connected to the process unit for storing data from the process unit and being accessed data by the process unit; and
an illuminator unit electrically connected to the process unit, wherein the illuminator unit is controlled by orders from the process unit when the process unit determines status based on the signals from the sensor unit and the mode signal from the backend central control system.

2. The monitoring apparatus as claimed in claim 1, wherein the process unit sends an order to the illuminator unit to switch on the illuminator unit when the mode signal from the backend central control system is directed to a detecting mode and the sensor unit detects moving approaching object in the detecting mode.

3. The monitoring apparatus as claimed in claim 1, wherein the process unit does not send any order to the illuminator unit to switch on the illuminator unit when the mode signal from the backend central control system is directed to a normally closed mode and the sensor unit detects moving approaching object in the normally closed mode.

4. The monitoring apparatus as claimed in claim 1, wherein multiple time periods are defined in the time mode, the process unit sends an order to the illuminator unit to switch on when the sensor unit detects moving approaching object during at least one of the multiple time periods; the process unit does not send any order to the illuminator unit to switch on when the mode signal from the backend central control system is directed to a time mode and the sensor unit detects moving approaching object during the others of the multiple time periods.

5. The monitoring apparatus as claimed in claim 1, wherein the process unit sends signals to the backend central control system via the transmission unit when the mode signal from the backend central control system is directed to an abnormal report mode and the process unit determines an abnormal status in the abnormal report mode.

6. The monitoring apparatus as claimed in claim 1, wherein the process unit has a function of counting to count number of signal sending from the sensor unit.

7. The monitoring apparatus as claimed in claim 1, wherein the transmission unit is a wireless transmission unit and the sensor unit is a passive infrared sensor.

8. The monitoring apparatus as claimed in claim 1 further comprising a switch unit electrically connected to the process unit and the illuminator unit, wherein the illuminator unit is controlled by the process unit via the switch unit.

9. The monitoring apparatus as claimed in claim 1, wherein the switch unit is a relay.

10. The monitoring apparatus as claimed in claim 1, wherein the process unit has a function of timing to calculate a time interval.
